(19) United States
(12) Patent Application Publication
(10) Pub. No.: US 2019/0372428 A1
(43) Pub. Date: Dec. 5, 2019

(54) VIBRATION MOTOR AND METHOD OF MANUFACTURING VIBRATION MOTOR

(71) Applicants: Nidec Corporation, Kyoto (JP); NIDEC COPAL CORPORATION, Tokyo (JP)

(72) Inventors: Masaru WADA, Tokyo (JP); Koya SATO, Kyoto (JP)

(21) Appl. No.: 16/478,211

(22) PCT Filed: Jan. 16, 2018
(86) PCT No.: PCT/JP2018/000889

§ 371 Date: Jul. 16, 2019

Related U.S. Application Data
(60) Provisional application No. 62/446,990, filed on Jan. 17, 2017.

(51) Int. Cl. H02K 7/06; B23K 26/22

(52) U.S. Cl. CPC H02K 7/063; B23K 26/22

(57) ABSTRACT

A vibration motor includes a motor including a rotor including a shaft disposed along a center axis and a stator radially opposed to the rotor, a metal vibrator including a groove in which one end in an axial direction of the shaft is disposed, a caulk that is located at an opening facing in a radial direction of the groove and fixes a circumferential surface of the shaft, and a weld that fixes the vibrator and the shaft at a position different from that of the caulk.

### CROSS REFERENCE TO RELATED APPLICATIONS

This is a U.S. national stage of PCT Application No. PCT/JP2018/000889, filed on Jan. 16, 2018, and priority under 35 U.S.C. § 119(a) and 35 U.S.C. § 365(b) is claimed from U.S. Provisional Application No. 62/446,990, filed Jan. 17, 2017; the entire disclosures of each application being hereby incorporated herein by reference.

### 1. Field of the Invention

The present disclosure relates to a vibration motor and a method of manufacturing a vibration motor.

### 2. BACKGROUND

Conventionally, a vibrator of the vibration motor is often attached to a shaft of a motor by caulking or press fitting.

However, in applications requiring high reliability, there is a demand for a structure in which the vibrator hardly drops out even if vibration or temperature shock is applied.

### SUMMARY

Example embodiments of the present disclosure provide highly reliable vibration motors in which dropout of a vibrator is reduced or prevented.

According to a first example embodiment of the present disclosure, a vibration motor includes a motor including a rotor including a shaft disposed along a center axis and a stator radially opposed to the rotor, a metal vibrator including a groove in which one end in an axial direction of the shaft is disposed, a caulk located at an opening facing in a radial direction of the groove and fixes a circumferential surface of the shaft, and a weld that fixes the vibrator and the shaft at a position different from that of the caulk.

According to a second example embodiment of the present disclosure, a method of manufacturing a vibration motor including a motor including a rotor including a shaft disposed along a center axis, and a stator radially opposed to the rotor, and a metal vibrator including a groove in which an end on one side in an axial direction of the shaft is disposed, the method including pressing a pressurizing member radially against an opening of the groove to deform the opening in a state where the end on one side in the axial direction of the shaft is disposed in the groove of the vibrator, and welding the vibrator and the shaft while the vibrator and the shaft are fixed by the pressurizing member.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a plan view of a vibration motor according to an example embodiment of the present disclosure.

FIG. 2 is a side view illustrating a vibration motor of an example embodiment of the present disclosure viewed in an axial direction.

FIG. 3 is an enlarged partially plan view illustrating an end on one side in the axial direction of a vibration motor of an example embodiment of the present disclosure.

FIG. 4 is a view illustrating a vibration motor of an example embodiment of the present disclosure viewed from a side orthogonal to the axial direction.

FIG. 5 is a sectional view illustrating a caulk of a vibration motor of an example embodiment of the present disclosure.

FIG. 6 is a side view illustrating a vibration motor manufacturing device of an example embodiment of the present disclosure.

FIG. 7 is an explanatory view of a laser welding process.

### DETAILED DESCRIPTION

Hereinafter, example embodiments of the present disclosure will be described with reference to the drawings.

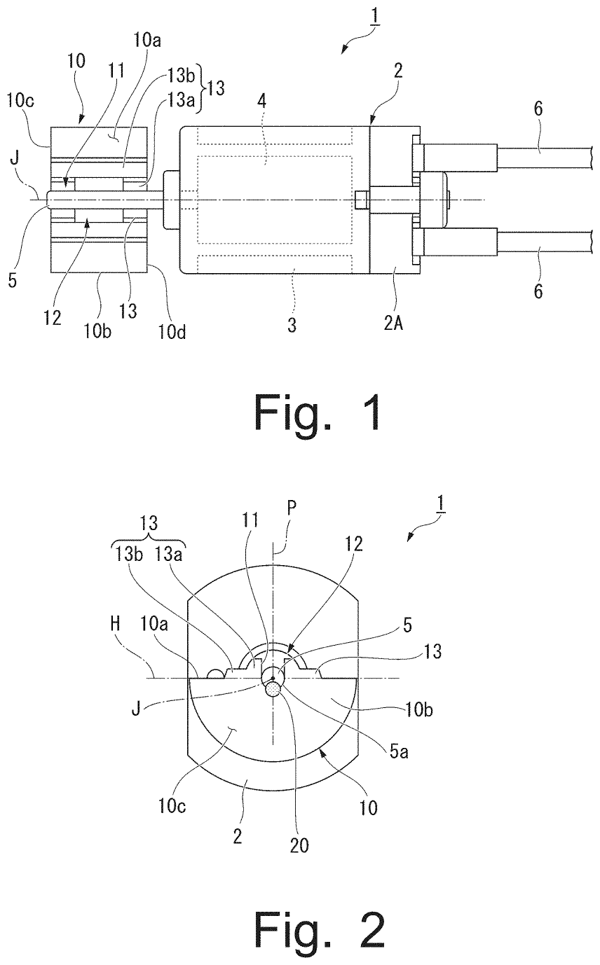

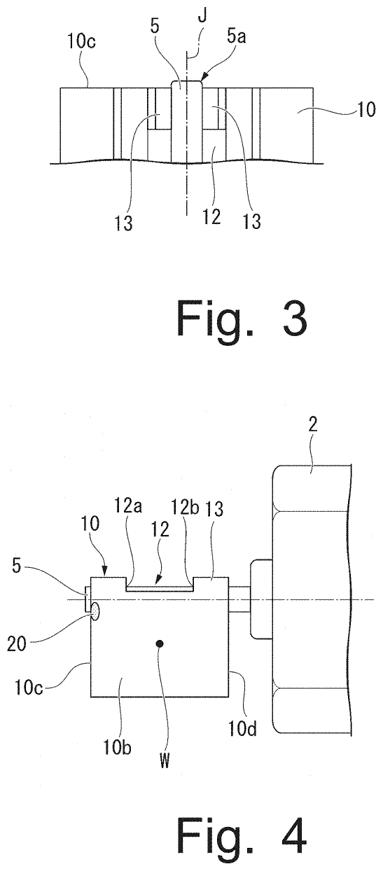

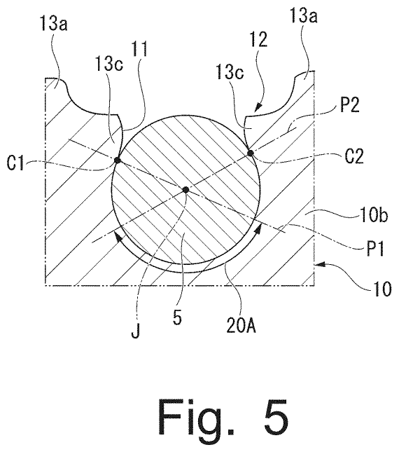

FIG. 1 is a plan view of a vibration motor according to the present example embodiment. FIG. 2 is a side view illustrating the vibration motor of the present example embodiment viewed in an axial direction. FIG. 3 is an enlarged partially plan view illustrating an end on one side in the axial direction of the vibration motor of the present example embodiment. FIG. 4 is a view illustrating the vibration motor of the present example embodiment viewed from a side orthogonal to the axial direction. FIG. 5 is a sectional view illustrating a caulking part of the vibration motor of the present example embodiment.

A vibration motor 1 of the present example embodiment includes a motor 2 and a metal vibrator 10 coupled to the motor 2. In the present example embodiment, the motor 2 is a DC motor with a brush. The motor 2 may be a brushless DC motor.

The motor 2 includes a motor case 2A, a rotor 4 including a shaft 5 disposed along a center axis J, and a stator 3 radially opposed to the rotor 4. The stator 3 is constructed with a permanent magnet fixed to an inner surface of the motor case 2A. The rotor 4 includes a core fixed to the shaft 5, a coil wound around the core, and a commutator fixed to the shaft 5. A brush that makes contact with the commutator is disposed in the motor case 2A. Two lead wires 6 are connected to the brush in the motor case 2A.

In the present example embodiment, a direction parallel to the center axis J is simply referred to as an “axial direction”. In the axial direction, a direction from the motor 2 toward the vibrator 10 is referred to as one side in the axial direction, and a direction from the vibrator 10 toward the motor 2 is referred to as the other side in the axial direction. One side in the axial direction is a direction in which the shaft 5 protrudes from the motor 2 along the center axis J, and is a leading end side of the shaft 5. The other side in the axial direction is a base end side of the shaft 5. A radial direction about the center axis J is simply referred to as a “radial direction”. In the radial direction, a direction coming close to the center axis J is called a radial inside, and a direction separating from the center axis J is called a radial outside. A circumferential direction about the center axis J is simply referred to as a “circumferential direction”.

The vibrator 10 is a substantially semi-cylindrical metal member centered on the center axis J. The vibrator 10 includes a fan-shaped eccentric load part 10b that extends in the radial direction from the center axis J when the eccentric load part 10b is viewed in the axial direction. A center angle of the fan shape is 180° when the eccentric load part 10b is viewed in the axial direction. For example, the vibrator 10 is made of a high specific gravity metal such as tungsten and molybdenum or an alloy containing the high specific gravity metal. For example, the vibrator 10 is prepared by powder metallurgy in which a tungsten powder is used.

The vibrator 10 has a groove 11 in which an end on one side in the axial direction of the shaft 5 is disposed. The groove 11 is located at a center of the fan shape of the eccentric load part 10b when viewed in the axial direction. The groove 11 is a linear concave groove opened to one side in the radial direction. The groove 11 extends along the center axis J, and is open to end faces 10c, 10d on both sides in the axial direction. The vibrator 10 includes two sidewalls 13 disposed across the opening of the groove 11 and a flat portion 10a that extends radially outward from an end on the outside in the radial direction of each of the two sidewalls 13. As illustrated in FIG. 2, the center axis J is located in a horizontal plane H including the flat portion 10a while the flat portion 10a is disposed along a horizontal direction. The groove 11 is open upward in a vertical direction P, which is orthogonal to the horizontal plane H while passing through the center axis J.

As illustrated in FIG. 1, the sidewall 13 extends in the axial direction along the center axis J. The sidewall 13 extends from the end on one side in the axial direction of the eccentric load part 10b to the end on the other side in the axial direction. In FIG. 2, the two sidewalls 13 protrude upward in the vertical direction P from the flat portion 10a. The sidewall 13 includes a first protrusion 13a that constitutes a sidewall of the groove 11 and a second protrusion 13b located radially outside the first protrusion 13a.

The sidewall 13 is step-wise when viewed in the axial direction. A protruding height of the first protrusion 13a from the flat portion 10a is larger than a protruding height of the second protrusion 13b from the flat portion 10a. The upper end in the vertical direction P of the two sidewalls 13 is an open end of the groove 11.

The vibration motor 1 includes a caulking part 12 that fixes the vibrator 10 and the shaft 5. As illustrated in FIG. 1, the caulking part 12 is located at an opening facing in the radial direction of the groove 11, and fixes an outer peripheral surface of the shaft 5. As illustrated in FIG. 5, the caulking part 12 is a portion obtained by pressing and deforming a part of the first protrusion 13a of the sidewall 13 from the opening of the groove 11 toward a bottom of the groove 11. In the caulking part 12, the outer peripheral surface of the shaft 5 is pushed by a deformation portion 13c obtained by deforming the first protrusion 13a along the outer peripheral surface of the shaft 5, thereby fixing the vibrator 10 to the shaft 5.

As illustrated in FIG. 4, the caulking part 12 is located at a central portion in the axial direction of the sidewall 13. The caulking part 12 extends in the axial direction. One end 12a in the axial direction of the caulking part 12 is located on one side in the axial direction with respect to a center of gravity W of the vibrator 10. The other end 12b in the axial direction of the caulking part 12 is located on the other side in the axial direction with respect to the center of gravity W of the vibrator 10. That is, the center of gravity W of the vibrator 10 is disposed within a range of the caulking part 12 in the axial direction. With this configuration, vibration causing the vibrator 10 to swing in the axial direction is prevented when the vibration motor 1 is operated. Consequently, loosening of the caulking part 12 is prevented.

As illustrated in FIGS. 2 and 4, the vibration motor 1 includes a welding part 20 that fixes the vibrator 10 and the shaft 5 at a position different from that of the caulking part 12. The welding part 20 is a coupling portion between the vibrator 10 and the shaft 5 by, for example, laser welding. A known welding method including gas welding and arc welding can be used as a method of welding the vibrator 10 and the shaft 5.

In the vibration motor 1 of the present example embodiment, because the vibrator 10 and the shaft 5 are fixed by the caulking part 12 and the welding part 20, a dropout of the vibrator 10 is greatly prevented as compared with the case where the vibrator 10 is fixed only by caulking. The vibration motor 1 is a vibration motor suitable for applications requiring high reliability.

In the present example embodiment, the welding part 20 is located in the end face 10c on one side in the axial direction of the vibrator 10. The welding part 20 may be located in the end face 10d on the other side in the axial direction of the vibrator 10. Axial movement of the vibrator 10 and the shaft 5 can be prevented by welding the vibrator 10 and the shaft 5 in the end face 10c or the end face 10d of the vibrator 10.

In the vibration motor 1, as illustrated in FIG. 3, the shaft 5 protrudes from the end face 10c on one side in the axial direction of the vibrator 10 toward the one side in the axial direction. The shaft 5 includes a chamfer portion 5a at an end on one side in the axial direction. The chamfer portion 5a is tapered in the present example embodiment. Alternatively, the chamfer portion 5a may be a corner R portion in which a corner of the shaft 5 is rounded. As illustrated in FIG. 2, the welding part 20 is disposed from the chamfer portion 5a of the shaft 5 to the end face 10c on one side in the axial direction of the vibrator 10. With this configuration, the vibrator 10 and the shaft 5 are firmly welded because the region including the chamfer portion 5a of the shaft 5 and the end face 10c of the vibrator 10 is welded.

As illustrated in FIG. 3, the chamfer portion 5a is preferably disposed so as to protrude toward one side in the axial direction from the end face 10c of the vibrator 10. When a part of the chamfer portion 5a is located on the other side in the axial direction with respect to the end face 10c, a gap is generated between the open end of the groove 11 in the end face 10c and the chamfer portion 5a, and a volume melted during the welding is decreased. By causing the outer peripheral surface of the shaft 5 located on the other side in the axial direction to protrude from the end face 10c with respect to the chamfer portion 5a, the volume of the portion melted during the welding can be secured to enhance welding strength.

On the other hand, by positioning a part of the chamfer portion 5a on the other side in the axial direction with respect to the end face 10c, the shaft 5 can be shortened, and a total length in the axial direction of the vibration motor 1 can be shortened. Thus, as long as the welding strength in the welding part 20 can sufficiently be ensured, a part of the chamfer portion 5a may be located on the other side in the axial direction with respect to the end face 10c.

In the present example embodiment, as illustrated in FIG. 2, the welding part 20 is one welding spot located in the end face 10c of the vibrator 10. With this configuration, in order to fix the shaft 5 and the vibrator 10, laser spot welding needs to be performed at only one place in the end face 10c of the vibrator 10, and therefore the manufacturing can efficiently be performed.

The welding part 20 is disposed on a bottom surface side of the groove 11 with respect to the center axis J of the shaft 5 in the end face 10c on one side in the axial direction of the vibrator 10. The welding part 20 is disposed below the center axis J in the vertical direction P of FIG. 2. With this configuration, since the side opposite to the opening of the groove 11 in the radial direction is welded, a welding range is easily secured, and the strength is easily obtained.

In the present example embodiment, a preferable range where the welding part 20 is disposed is a range in a vicinity of the bottom surface of the groove 11 in the end face 10c. Specifically, as illustrated in FIG. 5, a plane P1 passing through a contact position C1 between the caulking part 12 and the shaft 5 and the center axis J of the shaft 5 and a plane P2 passing through a contact position C2 between the caulking part 12 and the shaft 5 and the center axis J of the shaft 5 are defined when viewed in the axial direction. The welding part 20 is located on the bottom surface side of the groove 11 with respect to the center axis J of the shaft 5 in the end face 10c on one side in the axial direction of the vibrator 10, and is disposed on an end edge of the groove 11 sandwiched between two planes P1, P2. That is, the welding part 20 is disposed inside an angle range 20A in FIG. 5 when viewed in the axial direction. The center of the welding part 20 may be disposed in the angle range 20A. Preferably, the entire welding part 20 is disposed in the angle range 20A.

With the above configuration, because the welding part 20 and the contact positions C1, C2 are located on opposite sides across the center axis J in the radial direction, the shaft 5 is fixed so as to be radially sandwiched between the caulking part 12 and the welding part 20. Consequently, the dropout of the vibrator 10 is prevented.

The welding part 20 can be positioned outside the angle range 20A as long as the welding region is sufficiently secured.

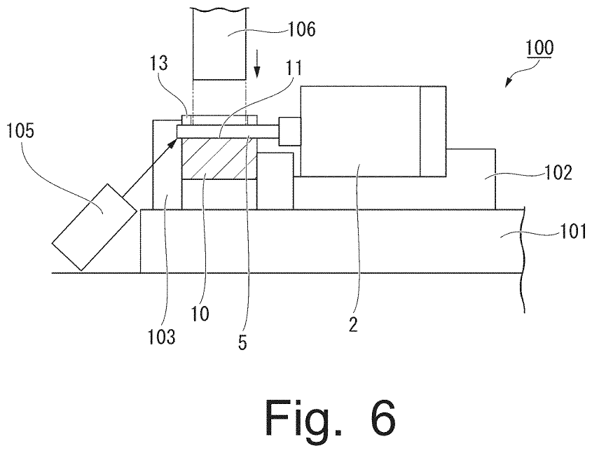

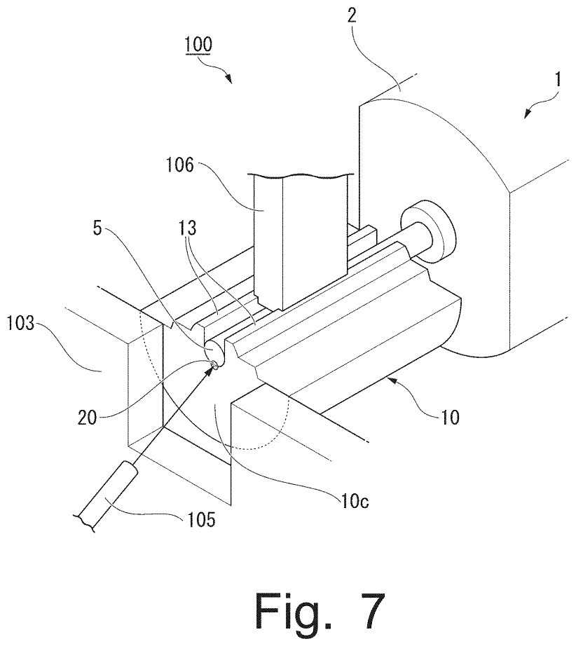

A method of manufacturing the vibration motor of the present example embodiment will be described below with reference to FIGS. 6 and 7. FIG. 6 is a side view illustrating a vibration motor manufacturing device of the present example embodiment. FIG. 7 is an explanatory view of a laser welding process.

As illustrated in FIG. 6, a vibration motor manufacturing device 100 of the present example embodiment includes a base 101, a motor fixing unit 102, a vibrator fixing unit 103, a laser emitting unit 105, and a pressurizing member 106. The base 101 is a support for the entire manufacturing device, and the motor fixing unit 102 and the vibrator fixing unit 103 are disposed on the base 101.

The motor fixing unit 102 supports the motor 2 in a posture in which the shaft 5 extends in the horizontal direction. The motor fixing unit 102 supports the motor 2 while the motor 2 is positioned in the horizontal direction.

The vibrator fixing unit 103 supports the vibrator 10 in a posture in which the groove 11 is open vertically upward. In the present example embodiment, the flat portion 10a of the eccentric load part 10b is horizontally disposed. The vibrator fixing unit 103 supports the vibrator 10 while the vibrator 10 is positioned in the horizontal direction.

The laser emitting unit 105 irradiates a boundary between the shaft 5 and the vibrator 10 with laser light to perform the laser welding. The laser emitting unit 105 may be fixed to the base 101, or supported by another support member.

The pressurizing member 106 is disposed vertically above the region where the vibrator 10 is disposed in the vibrator fixing unit 103. The pressurizing member 106 is disposed vertically above the sidewall 13 of the vibrator 10. The pressurizing member 106 is connected to a drive device (not illustrated) to constitute a caulking device. The pressurizing member 106 is movable in the vertical direction.

The method of manufacturing the vibration motor 1 using the vibration motor manufacturing device 100 includes a first process of disposing the motor 2 and the vibrator 10 and a second process of fixing the shaft 5 and the vibrator 10.

In the first process, the vibrator 10 is positioned and fixed to the vibrator fixing unit 103. The motor 2 is positioned and fixed to the motor fixing unit 102. In the first process, an end on one side in the axial direction of the shaft 5 is inserted into the groove 11 of the vibrator 10.

In the second process, the pressurizing member 106 is moved vertically downward while the end on one side in the axial direction of the shaft 5 is disposed in the groove 11 of the vibrator 10. Consequently, the pressurizing member 106 is pressed against the opening of the groove 11 to deform the opening of the groove 11, and the vibrator 10 and the shaft 5 are fixed by caulking. The caulking part 12 is provided in the vibration motor 1 through this process.

In the second process, the vibrator 10 and the shaft 5 are welded while the vibrator 10 and the shaft 5 are fixed by the pressurizing member 106. That is, as illustrated in FIG. 7, while the pressurizing member 106 is pushed into the sidewall 13, the end faces in the axial direction of the shaft 5 and the vibrator 10 are irradiated with the laser light emitted from the laser emitting unit 105. Consequently, parts of the shaft 5 and the vibrator 10 are welded. Through this process, the welding part 20 is provided in the vibration motor 1.

In the manufacturing method of the present example embodiment, the caulking and welding between the vibrator 10 and the shaft 5 are performed at one time in the second process. Consequently, manufacturing efficiency is greatly improved as compared with the case where the caulking and welding are separately performed. Because the welding is performed while the pressurizing member 106 is pressed to fix the vibrator 10 and the shaft 5, reproducibility of the disposition of the caulking part 12 and the welding part 20 is enhanced, and the vibration motor 1 having excellent reliability can be manufactured.

In the second process, the vibrator 10 and the shaft 5 are preferably welded at a position where the pressurizing member 106 comes closest to the shaft 5. With this manufacturing method, the welding can be performed at a position where the deformation of the caulking part 12 is completed, and relative position accuracy between the caulking part 12 and the welding part 20 is further enhanced.

In the present example embodiment, in the second process, the shaft 5 is irradiated with the laser light from an oblique direction while the end on one side in the axial direction of the shaft 5 is protruded from the end face 10c on the one side in the axial direction of the vibrator 10 toward the one side in the axial direction, thereby welding the shaft 5 and the vibrator 10. With this manufacturing method, the boundary region between the shaft 5 and the vibrator 10 can easily be welded by the laser welding. In the vibrator 10, the end face 10c different from the surface in which the caulking part 12 is provided is irradiated with the laser light, so that the welding can efficiently be performed without obstructing the caulking process.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-10. (canceled)

11. A vibration motor comprising:
a motor including a rotor including a shaft disposed along a center axis and a stator radially opposed to the rotor;
a metal vibrator including a groove in which one end in an axial direction of the shaft is disposed;
a caulk that is located at an opening facing in a radial direction of the groove and fixes a circumferential surface of the shaft; and
a weld that fixes the vibrator and the shaft at a position different from that of the caulk.

12. The vibration motor according to claim 11, wherein the weld is located at an end surface on a first side or a second side in an axial direction of the vibrator.

13. The vibration motor according to claim 12, wherein
the shaft protrudes from the end surface on the first side in the axial direction of the vibrator toward the second side in the axial direction, and includes a chamfer at an end on the first side in the axial direction of the vibrator; and
the weld extends from the chamfer of the shaft to the end surface on the first side in the axial direction of the vibrator.

14. The vibration motor according to claim 11, wherein the weld is a welding spot at one location.

15. The vibration motor according to claim 14, wherein the weld is disposed on a bottom surface side of the groove with respect to a center axis of the shaft in the end surface on the first side in the axial direction of the vibrator.

16. The vibration motor according to claim 15, wherein
when two planes passing through one of two contact positions between the caulk and the shaft and the center axis of the shaft are defined as viewed in the axial direction;
the weld is disposed on the bottom surface side of the groove with respect to the center axis of the shaft and on an end edge of the groove sandwiched between the two planes in the end surface on the first side in the axial direction of the vibrator.

17. The vibration motor according to claim 11, wherein
the caulk extends in an axial direction; and
a first end in the axial direction of the caulk is located on the first side in the axial direction with respect to a center of gravity of the vibrator and a second end in the axial direction of the caulk is located on the second side in the axial direction with respect to the center of gravity of the vibrator.

18. A method of manufacturing a vibration motor including a motor including a rotor including a shaft disposed along a center axis, and a stator radially opposed to the rotor, and a metal vibrator including a groove in which an end on a first side in an axial direction of the shaft is disposed, the method comprising:
radially pressing a pressurizing member against an opening of the groove to deform the opening in a state where the end on the first side in the axial direction of the shaft is disposed in the groove of the vibrator; and
welding the vibrator and the shaft while the vibrator and the shaft are fixed by the pressurizing member.

19. The method of manufacturing a vibration motor according to claim 18, wherein the vibrator and the shaft are welded at a position where the pressurizing member is closest to the shaft.

20. The method of manufacturing a vibration motor according to claim 18, wherein the vibrator and the shaft are welded by irradiating the shaft with laser light from an oblique direction in a state where the end on the first side in the axial direction of the shaft is protruded from an end surface on the first side in the axial direction of the vibrator.
